(19) United States
(12) Patent Application Publication
(10) Pub. No.: US 2025/0272538 A1
(43) Pub. Date: Aug. 28, 2025

(54) CONTROL OF INPUT, OUTPUT AND PROCESSING OF ARTIFICIAL INTELLIGENCE MODELS

(71) Applicant: Microsoft Technology Licensing, LLC, Redmond, WA (US)

(72) Inventors: Isuru Chamara PATHIRANA, Seattle, WA (US); Marcin Maciej STANKIEWICZ, Redmond, WA (US); Kumar RAJEEV, Redmond, WA (US); Glenn F. EVANS, Kirkland, WA (US); Priya Rakesh PATEL, Seattle, WA (US)

(73) Assignee: Microsoft Technology Licensing, LLC, Redmond, WA (US)

(21) Appl. No.: 18/759,785

(22) Filed: Jun. 28, 2024

Related U.S. Application Data
(60) Provisional application No. 63/556,746, filed on Feb. 22, 2024.

(51) Int. Cl. G06N 3/045; G06F 21/10; G06F 21/60

(52) U.S. Cl. CPC G06N 3/045; G06F 21/1074; G06F 21/602

(57) ABSTRACT

Examples of the present disclosure describe systems and methods for providing control of input, output, and processing of an AI model. In examples, a request to execute an AI model implemented by a client device is received, where the AI model is associated with one or more licenses that specify a protection level that is applied to one or more portions of the AI model during the AI model runtime. In response to the request, the AI model is translated to a first set of commands in an intermediate language. The first set of commands is translated into a second set of commands for a hardware device of the client device. The second set of commands is translated into microcode that is executable by the hardware device. The hardware device then executes the microcode to generate an output in furtherance of the request.

### BACKGROUND

Artificial intelligence (AI) models have been developed and leveraged for several cloud-based computing environments. Recently, there has been an interest in developing and leveraging AI models for client devices. However, one of the challenges associated with distributing AI models to client devices is protecting the AI models from being copied or stolen after the AI models have been implemented on the client devices.

It is with respect to these and other general considerations that the aspects disclosed herein have been made. Also, although relatively specific problems may be described, it should be understood that the examples should not be limited to solving the specific problems identified in the background or elsewhere in this disclosure.

### SUMMARY

Examples of the present disclosure describe systems and methods for providing control of input, output, and processing of an AI model. In examples, a request to execute an AI model implemented by a client device is received, where the AI model is associated with one or more licenses that specify a protection level that is applied to one or more portions of the AI model during the AI model runtime. In response to the request, the AI model is translated to a first set of commands in an intermediate language. The first set of commands is translated into a second set of commands for a hardware device of the client device. The second set of commands is translated into microcode that is executable by the hardware device. The hardware device then executes the microcode to generate an output in furtherance of the request.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Examples are described with reference to the following figures.

FIGS. 1A-1B depict an example system for implementing the distributed AI-model security architecture discussed herein.

FIG. 2A depicts another example system for implementing the distributed AI-model security architecture discussed herein.

FIG. 2B depicts another example system for implementing the distributed AI-model security architecture discussed herein.

FIG. 2C depicts another example system for implementing the distributed AI-model security architecture discussed herein.

FIG. 2D depicts another example system for implementing the distributed AI-model security architecture discussed herein.

FIG. 3 depicts an example communication diagram for implementing the distributed AI-model security architecture discussed herein.

FIG. 4 depicts an example computing environment for providing control of input, output, and processing of an AI model.

FIG. 5 depicts another example method for providing control of input, output, and processing of an AI model.

FIG. 6 is a block diagram illustrating example physical components of a computing device with which aspects of the technology may be practiced.

### DETAILED DESCRIPTION

AI models are programs that apply algorithms to data to detect patterns in the data, make predictions or conclusions about the data, and/or to perform actions based on the predictions or conclusions. As briefly discussed above, there has recently been an interest in developing and leveraging AI models for client devices. However, implementing AI models that have traditionally been leveraged in cloud-based computing environments in client devices potentially poses challenges. One such challenge is protecting an AI model that has been implemented in a client device from being copied or stolen from the client device.

The present disclosure provides a solution to the above-described challenges of securing AI models implemented on client devices. Embodiments of the present disclosure describe systems and methods for providing control of input, output, and processing of an AI model. In examples, a request to execute an AI model implemented by a client device is received, where the AI model is associated with one or more licenses that specify a protection level that is applied to one or more portions of the AI model during the AI model runtime. In response to the request, the AI model is translated to a first set of commands in an intermediate language. The first set of commands is translated into a second set of commands for a hardware device of the client device. The second set of commands is translated into microcode that is executable by the hardware device. The hardware device then executes the microcode to generate an output in furtherance of the request.

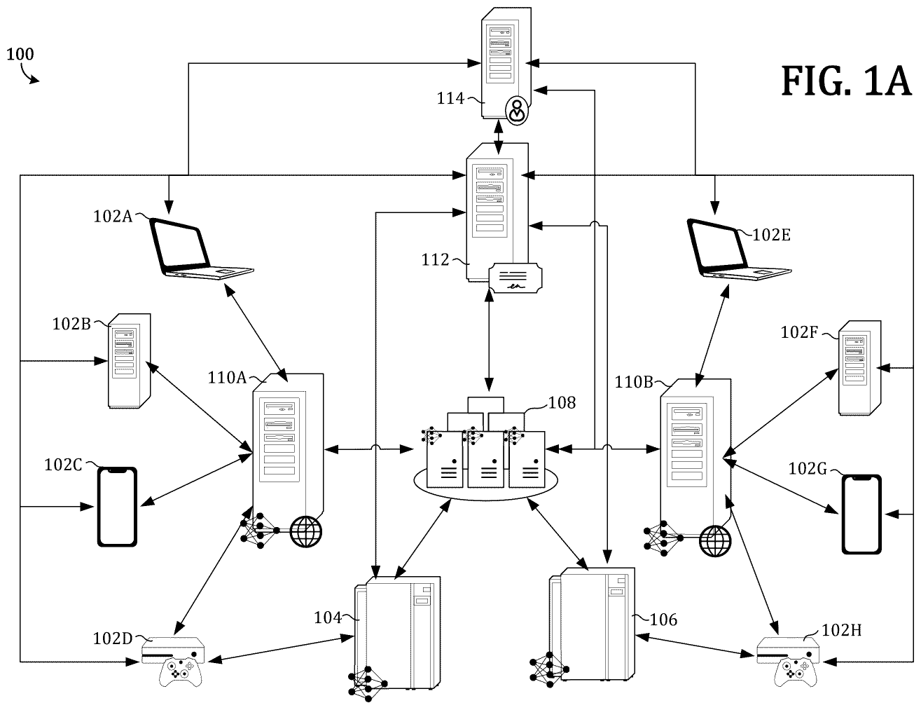

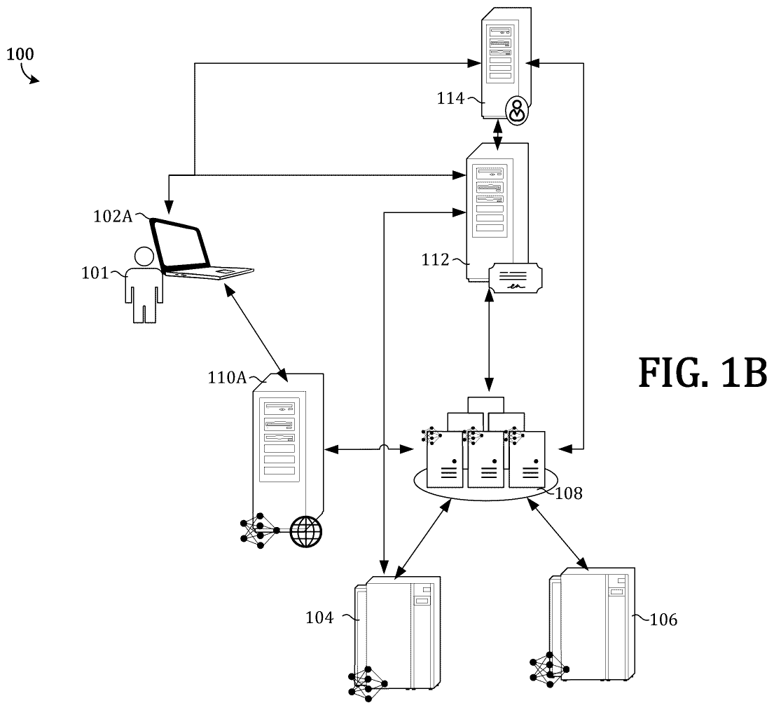

FIGS. 1A-1B depict an example system 100 for implementing the distributed AI-model security architecture discussed herein. System 100 is discussed first with reference to FIG. 1A and then a particular example of an AI model transfer is discussed with reference to FIG. 1B.

The system 100 includes a plurality of client devices 102, which are depicted as discrete client devices 102A-H. The client devices 102 ultimately receive and execute the models discussed herein. The client devices 102 may vary from many different types of devices, such as personal computers, laptops, tablets, smartphones, smart devices, gaming consoles, and even on-premises servers, among others.

The system 100 further includes a centralized server system 108 and a plurality of distributed servers 110, which are shown as a first distributed server 110A and a second distributed server 110B. The system 100 also includes a licensing server 112 and an account server 114. A model creation server 104, belonging to a model creator, and a training set server 106, belonging to a training set curator, may also be included in the system 100.

When a new AI model is created by a model creator, the AI model is initially stored in the model creation server 104. The model creator, which may be an entity (e.g., an individual user or a group of users) or a computing system (e.g., an automated model creation application, service, or system of one or more computing devices) then encrypts the AI model to form an encrypted model. The model creator, which may also be an entity or a computing system, also has access to the decryption key for decrypting the model. The decryption key may be the same as the encryption key in some examples. In other examples, the encryption key may be different from the decryption key. For instance, the encryption key may be a public key and the decryption key may be private key.

The encrypted model may also be compressed. Alternatively, the model may be compressed prior to being encrypted. The models tend to be very large in size (e.g., 1 GB or orders larger). As a result, reducing the storage and transmission size of the model is desirable. Accordingly, the model may be compressed on the model creation server 104 (and/or any other servers discussed herein that store the model). Examples of compression algorithms include Huffman coding algorithms, Shannon-Fano Coding algorithms, LZ77 algorithms, LZR algorithms, and Run Length Encoding algorithms. Other compression techniques used to compress the encrypted or unencrypted model include post training quantization (e.g., transforming model weights into lower precision representations) and pruning (e.g., removing model weights that contribute nominally to the model's overall performance).

The types of models that are created may be any type of ML/AI model, such as language models (LMs) and/or neural networks (NNs). For instance, large LMs (LLMs) and/or small LMs (SLMs) may be distributed and implemented with the technology discussed herein. Convolutional NNs (CNNs) and/or recurrent NNs (RNNs) may also be distributed and implemented. RNNs are often used for video and audio processing such as SuperResolution, camera noise reduction and processing, and/or audio microphone data enhancements (e.g. background noise removal such as music, dog barking, avatars). CNNs are often used for image processing and object detection.

The model itself may have multiple components that may be encrypted differently in some examples. For instance, the model may be considered include a network layer topology (e.g., the model code) and a model data (e.g., the model weights). These elements may be encrypted with different keys and decrypted with different keys. Accordingly, access to different parts of the model may be individually controlled. This allows for additional protections of the model while the model is being stored on the various servers discussed herein. In addition, different licenses, with differing security requirements, may be associated with the different model components. This allows for further refinement of control of the model usage and distribution. In addition, different portions of differently trained models (of the same type) may be combined. For instance, the model code of one model may be combined with the model weights of another model.

The model package may also be stored and transmitted in various different forms. Once example format is container, such as an Open Neural Network Exchange (ONNX) format. The ONNX model-container format allows for the model to be shared and implemented between different AI platforms and tools (e.g. DirectML, PyTorch, etc.). The ONNX data is comprised of assets (model data, weights) and the model structure (operators and functional ‘code’, topology). Each portion of the package may require different levels of protection due to the value of the component. The model package (e.g., ONNX container) may be encrypted and/or the components within the package or container may be encrypted.

The encrypted model is then transmitted from the model creation server 104. In one example, the model creation server 104 transmits the encrypted model to the centralized server system 108. The centralized server system 108 may then distribute copies of the encrypted model to the distributed servers 110. Accordingly, in the example depicted, the centralized server system 108 distributes the encrypted model to the first distributed server 110A and the second distributed server 110B.

In other examples, the model creation server 104 may transmit the encrypted model directly to the client devices 102. For instance, the client devices 102 may download or sideload the model more directly from the model creators. In some examples, the encrypted model may also be pre-installed on the client devices 102 prior to the client devices being sold. For instance, the model creation server 104 may work with the device manufacturers to include the encrypted model as part of the firmware and/or software of the client devices 102 as delivered to end users.

While only a single model and a single model creator have been discussed for simplicity, the system 100 handles many models of various different types from potentially many different model creators. The different models may be appropriate for different uses and/or for different types of devices. For example, the different models may be of different sizes that may be more appropriate for mobile use cases versus desktop use cases. The models may also have varying accuracy, with higher accuracy generally resulting in larger sizes. The different models may also have different security requirements (e.g., some models may need to be more secure than others). The models may also have different performance attributes (e.g., mobile use cases may need results faster. Other differences between the models are also possible.

In addition to transmitting the encrypted model, the model creator also generates the security requirements for the encrypted model. The security requirements for the encrypted model are transmitted to the licensing server 112, where the security requirements are stored as part of a license package for the particular model. The license package includes a license that functions as a container for storing, in addition to the security requirements, usage information for the particular model. In addition to providing the security requirements to the licensing server 112, the decryption key for the model is also provided to the licensing server 112.

The security requirements that are incorporated into the license include device-level requirements and/or software-level requirements. For instance, a model creator may require that particular hardware security features are available on the requesting client device 102. Some client devices 102 may have outdated or less capable hardware, whereas other client devices will have higher-end security hardware. Ensuring the security features are available on the particular client device 102 prior to decryption helps prevent against various different kinds of attack vectors, ranging from AI/ML-specific attacks to classical memory-scraping attacks. The security requirements may be based on particular hardware protections, central processing unit (CPU) protections, and/or output protections available on the client device 102. The particular type of system may also be a requirement, such as the manufacturer of the system (e.g., Hewlett Packard, Dell, Microsoft). The security requirements may also have multiple tiers or levels that correspond to the resolution at which the model is allowed to operate, with higher capabilities corresponding to potentially higher resolutions.

More specifically, the security requirements and the license details can define who can use the model (e.g., user-level or account-level restrictions), what can use the model (e.g., device-level restrictions), how the model can be used (e.g., performance or usage restrictions), and/or when the model can be used (e.g., expiration periods, count limits).

The device-level restrictions may include restrictions on hardware or device identifiers and/or hardware manufacturers (e.g., Microsoft, Hewlett Packard, Dell). In some examples, a hardware root of trust (HROT) of the device is identified with a unique identifier by the manufacturer. These identifiers may be known by the model and/or training set creators and included within the license as a restriction, or effectively a permission list. For instance, a list of device or HROT identifiers may be included within the license as being approved to use the model (e.g., permit list). In other examples, a list of a list of device or HROT identifiers may be included within the license as being blocked to use the model (e.g., block list). In some examples, the permit or block lists may be based on device manufacturers. For instance, a model may be approved for use for all Microsoft or Dell devices.

In addition, the license may include restrictions on which organizations may use the model. For instance, the HROT may also include additional data (e.g., metadata) about organization to which the device belongs. As an example, once the client device is on premise of the organization, the organization may load organization-identifying metadata into the HROT. This organization-identifying information may then be used as a security restriction similar to the above to approve devices belonging to a particular organization.

The license may also include security restrictions based on the specific hardware and/or software installed on the client device. For instance, the HROT may also include a listing of the hardware and/or software that is installed on the client device. For hardware devices, this may include neural processing units (NPUs), CPUs, graphics processing units (GPUs), and memory hardware, among other hardware used in client devices. The particular memory protections, CPU protections, and hardware protections that accelerators provide may also be included as security restrictions (and provided by the HROT) The security restrictions in the license may approve use of the model for only client devices including certain sets of hardware and/or minimum hardware requirements. In other examples, the security restrictions in the license may restrict usage of the model of devices with certain types of hardware. For example, a model creator may not allow a model to run on devices with a certain type of NPU and/or memory type.

The HROT may also include software capabilities of the particular client device, which may be used as security requirements in the license. For instance, certain devices may be provisioned with additional capabilities, such as the ability to process and/or decode certain types of data. As one example, some devices may have the capability to process device H.264 video streams, whereas others do not, which may be based on purchases and/or other software licenses of the client device. For instance, a device manufacturer may produce a device with hardware that is capable of processing many different codecs, but not all of them are enabled when the device is originally manufactured. When a license to a particular codec is acquired by the client device, a software switch can be enabled to activate the decoder capabilities for the particular codec. The data identifying such enabled capabilities may be stored and/or accessed by the HROT and used as security requirements within the license for the model. Similar to the other security requirements, these capabilities may be used to grant or deny a license for the model (e.g., permit list or block list of capabilities). For instance, the license can require a check as to a hardware/software capability before granting the license. Other hardware/software capabilities may include features such as decoding LLM models, a large amount of available memory, support of certain ML operators and/or extensions. By receiving this type of hardware and/or software data from the HROT, the data comes in a trusted, cryptographically hardened manner.

The license may also define performance limits that may restrict the inputs and/or outputs of the model as well as the resolution of the model. For instance, tokens per second output rate may be limited or defined within the license. The input context window size may also be limited or defined within the license. The performance limits may also be tied to the device-level data (e.g., hardware and/or software of the client device). For instance, a first set of client devices have a first hardware configuration and may be granted higher performance limits, and a second set of client devices have a second hardware configuration and may be granted lower performance limits. Despite the different performance limits, both the first set and the second set of client devices are allowed to use the model.

As another example, the amount of usage of the model may be specified. For instance, a usage count may be specified in the license. The usage count limits the number of times that a model is executed. The usage count may be tracked using, for example, digital rights management (DRM) software implemented by or accessible to the client device 102. The DRM software may store the usage count as an integer value or store objects representative of the usage count (e.g., model access tokens, user authentication tokens, or result set delivery tokens). The license may also specify a usage time. For instance, a time period may be specified for how long the model is valid for (e.g., an expiration time). The license may also specify a credit amount. For instance, the credit amount may be indicated as a monetary amount or as a data processing quantity (e.g., a number of accesses or uses). The usage restrictions may also include a limit on concurrent uses of the model. For instance, the license may specify a maximum number of actively running models on the client device.

The license may also include restrictions related to the models and/or training data sets that can be combined and/or used together. For instance, a license for a training set may specify a list of models for which the training set may be used. This may be in addition to the types of restrictions set forth above. A license for model may similarly restrict the types of training sets with which the model may be used or modified. As such, models and the training sets with which they are used may be separately licensed (and encrypted) and control of the combination is also provided.

Similarly, because the model code and the model weights may be separately encrypted and associated with different decryption keys, they may also be separately licensed. In such examples, the license requirements for both the model-code license and the model-weights license must be met before the combination of the two may be implemented. Thus, the local combining of different model code and model weights may be controlled via the licensing architecture discussed herein.

The license for the model may also restrict changes or generation of derivates of the models. For instance, license may prevent a client device from modifying the model in any way or generating a derivative model from the locally running model.

Once the licensing server 112 has received the security restrictions or requirements and the decryption key(s) for model, the licensing server 112 then creates a licensing package for the model. The licensing package includes at least: (1) a license that defines the security requirements provided by the model creator; and (2) the decryption key(s) for the model. The licensing package may be associated with the model via a unique identifier (UID) for the particular model. For instance, the model may have a UID and the license package may be associated with the model via the same UID such that the licensing server 112 may identify the correct license package when a request for a license for a particular model is received. The licensing package is stored for later delivery and fulfillment of license requests.

The model creator and/or the operator of the centralized server system 108 may also have account-level and/or user-level requirements for use of the model. For instance, the security requirements defined in the license may be specific to software and/or hardware requirements of the client devices 102 (e.g., device-level security requirements). The model creator and/or the operator of the centralized server system 108 may also desire to restrict usage of the models to specific users and/or organizations. As an example, the model creator and/or the operator of the centralized server system 108 require a fee to paid to use the model and only those users or organizations with the fees paid are allowed to access the model.

These user-level requirements are transmitted to the account server 114 that manages authentication of the particular users of the client devices 102. For instance, when a request to the licensing server 112 is received, a request may also be received at the account server 114 to authenticate the user of the particular client device 102. If the account server 114 is able to authenticate the user, the account server 114 provides an authentication message to the licensing server 112 indicating the identity of the user and/or whether the user is authorized to have a license to the model.

When the licensing server 112 is able to: (1) verify the hardware and/or software requirements of the license based on data received from the requesting client device 102 and (2), in some examples, receive the authentication approval from the account server 114, the licensing server 112 transmits the licensing package for the model to the requesting client device 102. The client device 102 then also performs local security verifications and operations before extracting the decryption key from the license package, as discussed further herein.

Similar system operations may also be available for specialized training-set creators. For example, as discussed above, training set curation is also a particularly expensive process and security requirements are also required for developed training sets that may be used with the models discussed herein.

Similar to the models, the training-set creator generate an encrypted training set on the training set server 106. The encrypted training set is then transmitted, such as to the centralized server system 108 and/or more directly to the client devices 102 (e.g., sideloaded, downloaded, preloaded). In examples where the training set is transmitted to the centralized server system 108, the centralized server system 108 also transmits the encrypted training set to the distributed servers 110. The distributed servers 110 then provide the encrypted training set to the client devices 102 (e.g., upon request for the training set from the client devices 102).

The training-set creator then also defines the device-level security requirements for the training set with the licensing server 112. The decryption key for the training set is also transmitted from the training set server 106 to the licensing server 112. The licensing server 112 creates a licensing packaging with a license defining the security requirements for the training set and the decryption key for the training set. The training-set creator may also define the user-level security requirements with the account server 114.

Then, when a request for a license to the training set is received by the licensing server 112, the licensing server 112 processes the request similarly to the request for a license to a model as discussed above. For instance, once the licensing server 112 is able to verify the security requirements for the training set, the licensing package for the training set is delivered to the requesting client device 102. The client device 102 then performs additional security checks prior to extracting the decryption key from the licensing package.

For additional clarity, FIG. 1B depicts a subset of the system 100 shown in FIG. 1A. A particular example will now be discussed with respect to the components shown in FIG. 1B.

In an example, the first client device 102A is associated with a particular user 101. The user desires to utilize a specific model created by a model creator that operates model creation server 104. The user also desires to use the specific model with a specific training set curated by an operator of the training set server 106.

To identify the model and the training set, a request may first be sent to the licensing server 112 from the first client device 102A. This request may be for the specific model and/or training set and/or for a list of available models and/or training sets. As an example, the request provides the hardware and/or software details of the first client device 102A (and potentially the identity of the user 101) to the licensing server 112. The licensing server 112 then provides a listing of the available models and/or training sets for which the user 101 and/or the first client device 102A are allowed to download based on the security requirements. In other examples, the request is merely a request for models and/or training sets without identifying information about the first client device 102A and/or the user 101. In such examples, the licensing server 112 provides a list of all the available models and/or training sets that are available to be delivered from the distributed servers 110 (e.g., models and/or training sets that have been received by the centralized server system 108).

When a selection of the particular model and/or training set is received, a best-suited distributed servers 110 is selected based on the first client device 102A. For instance, a distance between the first client device 102A and all the distributed servers 110 may be compared to identify one of the distributed servers 110 that is located most closely to the first client device 102A. The distance may be a physical distance and/or a network architecture distance. For instance, based on a routing map or pings between the first client device 102A and the distributed servers 110, a particular one of the distributed servers 110 is selected that is closest (e.g., shortest latency) to the distributed servers 110. In the example depicted, the closest of the distributed servers 110 is the first distribution server 110A.

A new request for the model and/or training set may then be generated from the first client device 102A and sent to the first distribution server 110A. For instance, the licensing server 112 may provide the Internet Protocol (IP) address or other identifier of the first distribution server 110A to the first client device 102A along with a UID for the model and/or training set. The first client device 102A generates a request with the UID and sends the request to the first distribution server 110A. In other examples, the licensing server 112 may send a request to the first distribution server 110A with the address of the first client device 102A and a UID of the model and/or training set to cause the first distribution server 110A to transmit the model and/or training set to the first client device 102A. In either example, the requested model and/or training set is delivered to the first client device 102A.

In some examples, the request for the model and/or training set also causes a request for the licensing package for the model and/or training to be generated from the first client device 102A and provided to the licensing server 112. In other examples, an interrogation of the model and/or training data set first occurs on the first client device 102A before a request for the licensing package is generated.

The request for the licensing package may include hardware and/or software information about the first client device 102A. This device data may be used for attestation and verification. For example, hardware/software certificates, and/or other evidence, may be delivered as part of the device data. The licensing server 112 then verifies that the device data meets the security requirements set forth in the corresponding license(s).

In the current example, user-level security requirements are also required for the model and/or training set. User-identity data is provided to the account server 114. The user identity data may include a username and password as well as other verification data in some examples (e.g., dual-factor authentication). The account server 114 receives and authenticates the user 101. The authentication verification is provided to the licensing server 112.

Upon verifying that the device data meets the security requirements and receives the authentication verification, the licensing server 112 provides the license package(s) for the model and/or training set to the first client device 102A. The first client device 102A then processes the license package to extract the decryption key and decrypt the model and/or training set, as discussed further herein.

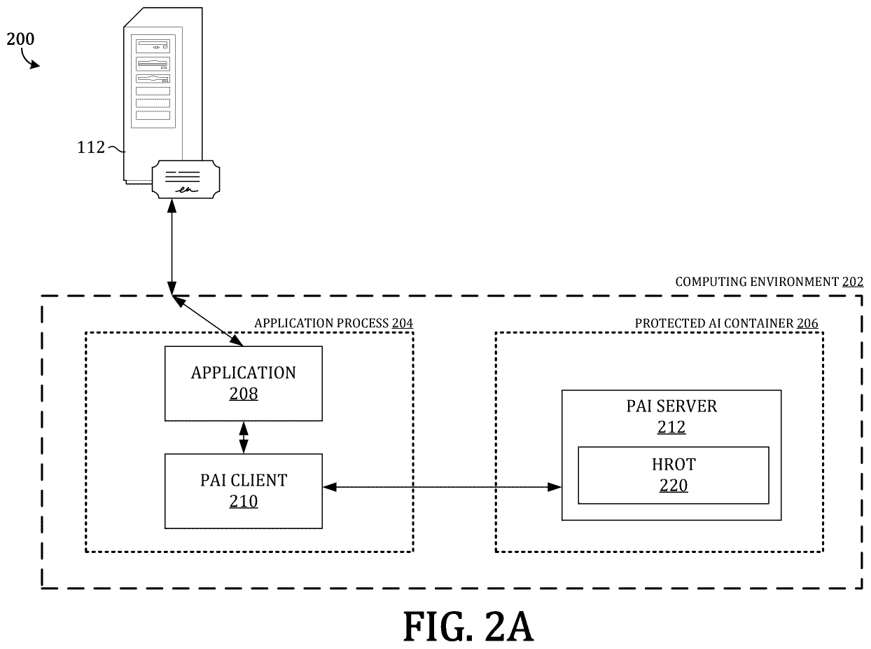

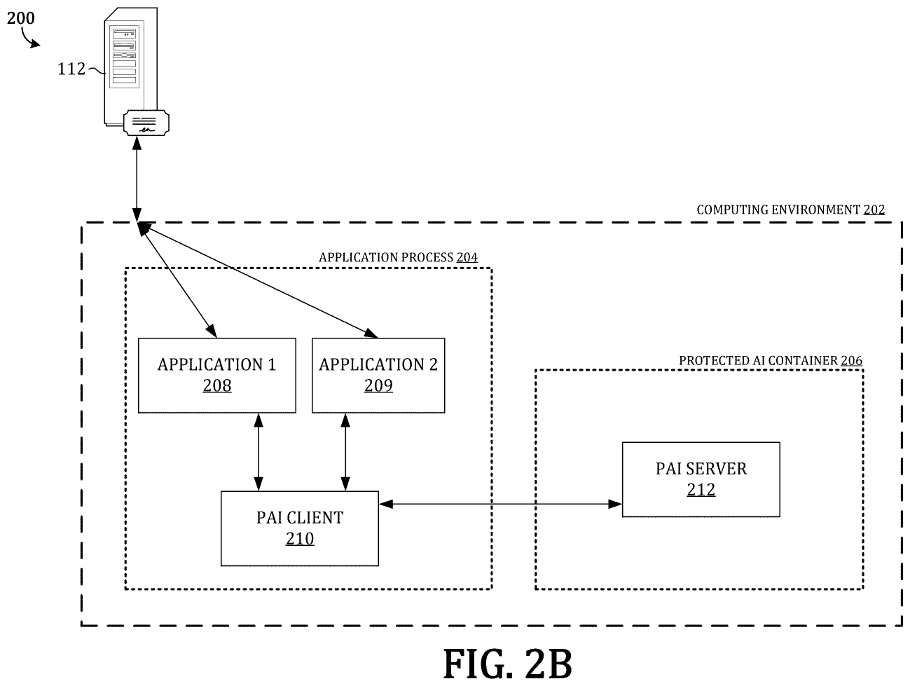

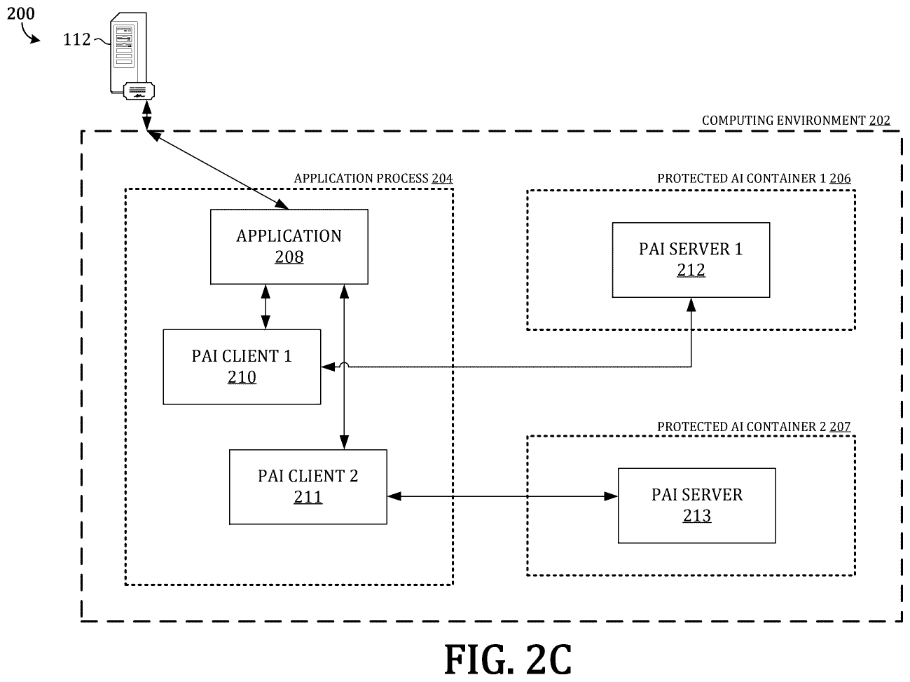

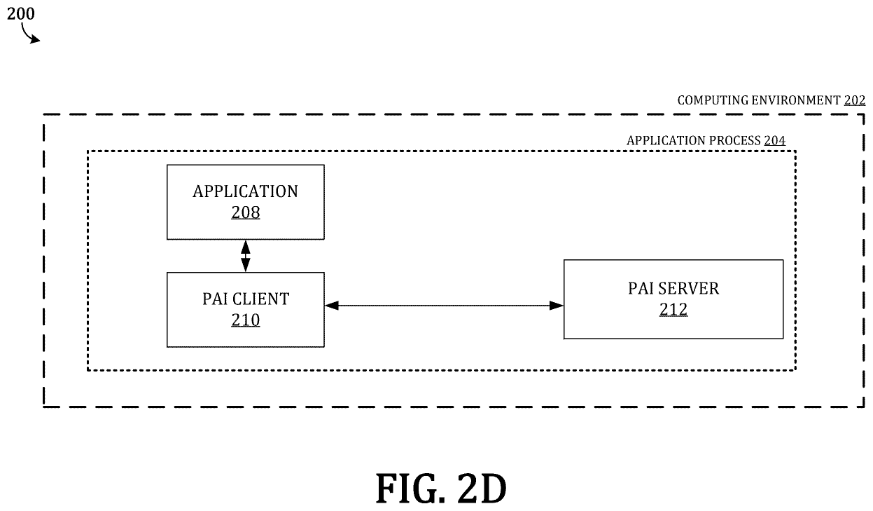

FIG. 2A depicts another example system 200 for implementing the distributed AI-model security architecture discussed herein. The system 200 includes the licensing server 112 and another computing environment 202. The computing environment 202, and/or a portion thereof, may be a client device 102. The computing environment 202 has received the model and/or training set. The computing environment includes an application process 204 and a protected AI (PAI) container 206. The application process 204 includes an application 208 and a PAI client 210. The application process 204 may also be considered a container in some examples. The PAI container 206 includes a PAI server 212.

The application process 204 and the PAI container 206 may operate on the same physical device. For instance, the PAI container 206 may be a separate, secure process from the application process 204. The PAI container 206 may also be implemented as an enclave (e.g., a secure network that is used to store and/or disseminate confidential data), a virtual machine (e.g., a compute resource that uses software instead of a physical computer to run programs, store data, and deploy applications), a hardware trust zone (e.g., a hardware-based security architecture that provides a secure software execution environment), an isolated execution environment (e.g., a secure software execution environment that enables the confidential execution of software), and/or an isolated security processor hardware (e.g., a dedicated hardware component that provides a secure software execution environment) on the same device as the application process 204. For instance, the PAI container may include or be a trusted execution environment (TEE). In other examples, the PAI container 206 may be implemented as a separate device from the application process 204.

The PAI server 212 performs the operations on the model and/or training set. For instance, the PAI server 212 performs the decryption operations, validation operations, and inference (e.g., input data processing) operations. In some instances, the PAI server 212 is implemented in C++, but other formats and languages are also possible.

The PAI client 210 may operate as an interface and/or library that hides the complexity of security solution of the PAI container 206 and PAI server 212 from the application 208. The application 208 interacts with the PAI container 206 using function calls, which may be simpler function calls than required to directly communicate with the model and/or PAI server 212. The PAI client 210 may then perform the operations to communication with the PAI server 212 and retrieve the results generated from the model.

A hardware root of trust (HROT) 220 exists within the PAI server 212. The HROT 220 is trusted by the licensing server 112 and can provide security data to the licensing server 112 (via the PAI client 210 and the PAI server 212). The HROT 220 also is trusted to enforce of the security requirements of the license for the model. For instance, the HROT 220 has access to, or hooks into, the corresponding hardware components, such as the memory, the NPU, GPU, and other types of hardware that may be used by the model. The HROT 220 may also configure the memory protections (e.g., encryption to dynamic random access memory (DRAM), protection of static random access memory (SRAM) memory access) for the device to comply with the security requirements.

Hardware-based security restrictions that are enforced by the HROT 220 provide for additional security for model usage. For instance, solely tying the model security to a user account is likely not a feasible solution because the user account is an abstraction controlled by the host operating system. The hardware itself cannot be as easily changed or manipulated.

The HROT 220 may be responsible for local enforcement of the security requirements in the license, and/or a subset thereof, such as the security restrictions and/or requirements discussed above. For instance, the HROT 220 is best positioned to ensure that the usage and performance restrictions set forth in the license are enforced (e.g., the model's tokens per second output rate, input context window size, hardware environment configuration, usage count, usage time, credit amount, or concurrency usage).

As some examples, the security requirements in the license that are enforced by the HROT 220 may include permissions for particular hardware features (e.g. a video or audio codec has been ‘purchased’/enabled on the machine). The amount of usage of the model can also be specified in the license and enforced by the HROT 220. For instance, a usage count may be specified in the license. The usage count limits the number of times that a model is executed. The HROT 220 monitors the number of times the model is executed and revokes functionality of the model once the count limit is reached. The license may also specify a usage time. For instance, a time period may be specified for how long the model is valid (e.g., an expiration time). The HROT implements a secure clock to monitor the time and revoke function of the model at expiration of the time period. The license may also specify a credit amount. For instance, the credit amount may include a data processing quantity. The HROT 220 monitors the processing resources consumed by the model operations (e.g., by monitoring the secure NPU/GPU processes) and revokes functionality of the model once the credit amount is reached.

The HROT 220 continues to monitor and enforce the security requirements of the license even after the initial verification. When the HROT 220 notices a condition that violates the security requirements of the license, the HROT 220 effectively locally revokes the local license by preventing functionality of the model from occurring. For instance, the HROT 220 can cause one or more hardware components to go into a blocked state with respect to data relating to the model. The prevention of the functionality may be related to the model directly or through control of the hardware to prevent the model from ultimately producing useful output. For instance, upon identifying a violation of the security requirements, the HROT 220 may remove decryption keys from the PAI client 210 so that the client can no longer decrypt data from the PAI server 212. Alternatively, instead of removing the decryption keys from the PAI client 210, the HROT 220 may cause the client to be blocked from using the decryption keys to decrypt data from PAI server 212. The HROT 220 can also block memory access, resulting in blank or null data when requests to such memory are issued.

Then, the next time communication is established between the PAI server 212 and the licensing server 112 (via the application 208 and PAI client 210), the PAI server 212 notifies the licensing server 112 that the security requirements are no longer met by the particular client. For instance, at different intervals, the licensing server 112 may be in communication with the PAI server 212 as check-in points to ensure continued compliance.

The application 208 may interact with the PAI server 212 via a web application programming interface (API). In some examples, the license may hold the decryption key for the model in a manner that is encrypted with the device certificate of the PAI server 212. The licensing server 112 may use its own certification to sign the license response that is provided to the application 208.

System 200 may also include a shared software development kit (SDK). The SDK includes the business logic, cryptographic operations, license generation, and validation data. The SDK may be used by both the PAI server 212 and the licensing server 112.

FIG. 2B depicts another example of system 200 for implementing the distributed AI-model security architecture discussed herein. The system 200 in FIG. 2B differs from the system 200 in FIG. 2A in that two applications are executing in the application process 204.

The application process 204 includes a first application 208 and a second application 209. After the model is securely installed in the PAI container 206, both the first application 208 and the second application 209 may interact with the model by sending commands to the PAI client 210. The PAI client 210 then communicates with the PAI server 212 on behalf of the applications 208-209. In this manner, the PAI server 212 and the model may remain secure while providing a single access point (e.g., the PAI client 210) for interaction with the secure model.

FIG. 2C depicts another example of system 200 for implementing the distributed AI-model security architecture discussed herein. The system 200 in FIG. 2C differs from the system 200 in FIG. 2A in that two models are in use in the computing environment 202.

In FIG. 2C, two different models have been installed in the computing environment 202. In some examples, the models could be implemented and operated by either the same PAI server and/or in the same PAI container. However, such implementation within the same secure environment may provide a possibility for an attack vector between the models themselves within the same environment. To avoid this potential attack vector or surface, the models are instead operated in two secure environments that are separated from one another. While more secure, the inclusion of additional servers or secure containers increases cost and overhead.

More specifically, in the example depicted, a first PAI container 206 includes a first PAI server 212. The first PAI server 212 operates a first model. The application 208 interacts with the first model via the first PAI client 210, which communicates with the first PAI server 212.

A second PAI container 207 includes a second PAI server 213. The second PAI server 213 operates a second model. The application 208 interacts with the second model via the second PAI client 211, which communicates with the second PAI server 213.

FIG. 2D another example of system 200 for implementing the distributed AI-model security architecture discussed herein. Unlike the example depicted in FIG. 2A, the example depicted in FIG. 2D is a lower-security, but less resource-intensive implementation. For instance, a license server is no longer implemented and a PAI container 206 is also no longer implemented.

In this example, rather than retrieving the decryption key for the model as part of a license package from a license server, the decryption key is received as part of the model package when the model package is downloaded or otherwise installed in the device. The model package may also define security requirements that are to be met before the decryption key can be used. In this situation, trust is put into the client device (e.g., computing environment 202) to perform the security verifications. In some examples, the client device is able to derive the decryption key from the model package based on a secret seed and key ID value. The seed may be randomly pre-generated and stored within the application 208, the PAI client 210, and/or the PAI server 212. The decryption key may also be generated based on values read from the model (so the seed cannot be read directly from the binary). The seed and key ID are then provided as input to a key derivation function that generates the content key.

In this example, the PAI server 212 also runs within the application process 204 rather than a separate, protected application process 204. In other examples, however, the PAI server 212 may run in a separate application process 204.

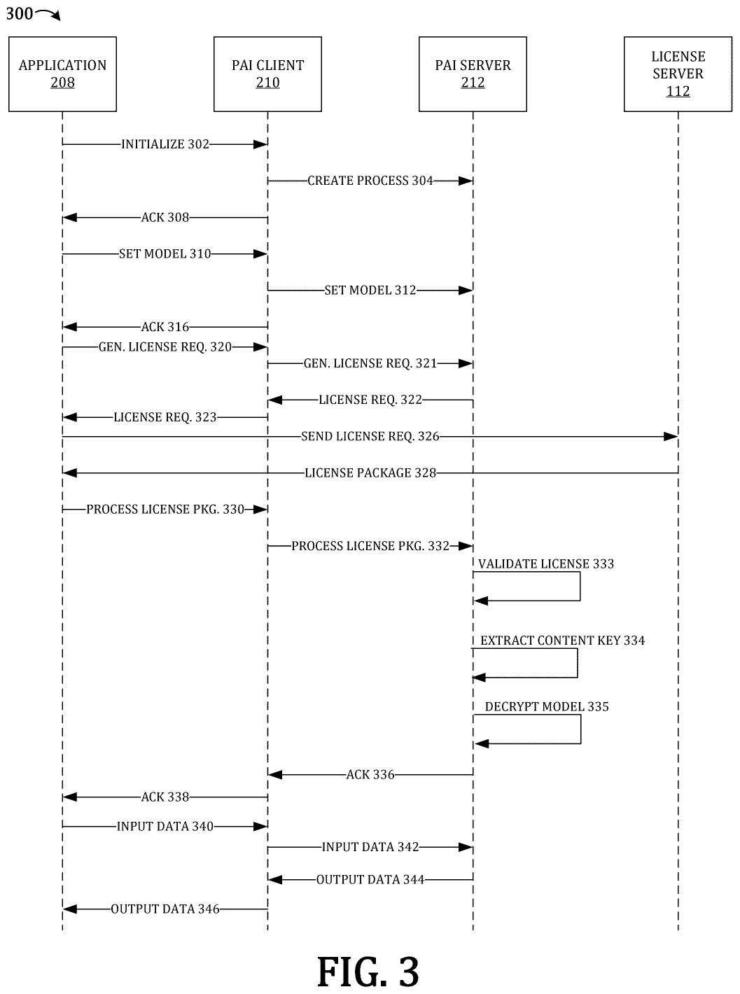

FIG. 3 depicts an example communication diagram 300 for implementing the distributed AI-model security architecture discussed herein. The communication diagram depicts communications between the application 208, the PAI client 210, the PAI server 212, and the licensing server 112, respectively.

An initialize message 302 is first sent from the application 208 to the PAI client 210. A create process message 304 is then sent from the PAI client 210 to the PAI server 212. The create process message 304 causes the creation of the PAI server 212 and/or the secure processes and containers associated with the PAI server 212. An acknowledgement message 308 may then be sent from the PAI client 210 to the application 208 indicating that the protected process has been created.

The application 208 then sends a set model message 310 to the PAI client 210 that may include the downloaded encrypted model package (e.g., an ONNX package including the model components). In other examples, the set model message 310 includes an indication of where the encrypted model is stored on the device (as the model has already been downloaded to the device). The PAI server 212 can then ultimately cause the model to be stored in the secure memory rather than unsecure memory when the model is initially downloaded. The set model message 312 is then provided to the PAI server 212 from the PAI client 210. The PAI server 212 then stores the encrypted model package in the secure memory to which the PAI server 212 has access. An acknowledgment message 316 may then be generated and provided to the application 208 to indicate that the encrypted model has been stored.

The application 208 then generates a request message 320 for a license request. This “request-for-a-request” message may be referred to herein as a GLR message 320. The GLR message 320 is then passed from the PAI client 210 to the PAI server 212 as GLR message 321. The PAI client 210 may also modify or augment the GLR message 321 for the PAI server 212.

In response to the GLR message 321, the PAI server 212 interrogates the stored model package to extract data about the model or from the model included in the license request. In some examples, the PAI server 212 also aggregates security data about the software and/or hardware of the computing environment 202, the application process 204, and/or the PAI process 206. For instance, the HROT 220 may examine the model to determine what the model requires and includes the attestation details that are likely needed by the license and/or by the licensing server 112 to approve the license request and deliver the license. As discussed above, the HROT 220 includes or has access to data or metadata about the hardware and/or software capabilities and/or configurations of the client device. These hardware and/or software capabilities and/or configurations of the client device are incorporated into the license request that is generated and passed from the PAI server 212. By generating this type of hardware and/or software data from the HROT 220, rather than from an untrusted application 208, the data is provided to the licensing server 112 in a trusted, cryptographically hardened manner. Thus, the licensing server 112 is able to make a higher-trust evaluation of the data when determining whether to grant the license for the model.

The license request that generated from the PAI server 212 may also be encrypted such that the PAI client 210 and/or the application 208 cannot read the license request itself. The licensing server 112, however, includes a decryption key and can decrypt the license request upon receipt.

The license request message 322 including the data about the model (or extracted from the model) and the device-level security data (where available) is then transmitted from the PAI server 212 to the PAI client 210. The PAI client 210 then sends a license request message 323 (containing substantially the same information) to the application 208.

Once the application 208 has received the license request message 323, the application 208 generates and sends a license request message 326 to the licensing server 112. The license request message 326 includes at least a portion of the data included in the license request message 323. For instance, the license request message 326 includes an identifier for the model for which a license is requested. The license request message 326 may also include the device-level security data from the PAI server 212.

The license request message 326 is processed by the licensing server 112, as discussed further herein. If the licensing server 112 approves the license request, a license package 328 is transmitted from the licensing server 112 to the application 208.

The application 208 generates a process-license-package message 330 and transmits the message to the PAI client 210. The process-license-package message 330 includes the license package for the model. The PAI client 210 processes the process-license-package message 330 and transmits its own process-license-package message 332 to the PAI server 212.

When the PAI server 212 receives the process-license-package message 331, the PAI server 212 then performs operations to process the received license package. The example operations include a validate-license operation 333, an extract-content-key operation 334, and a decrypt-model operation 335.

The validate-license operation 333 includes locally validating the security requirements set forth in the license. The validate-license operation 333 operation may also first determine that the license package received is valid, such as by checking that the license package came from an approved license server and/or is associated with an approved device identifier (e.g., media access control (MAC) address).

Once the license requirements are validated, the extract-content-key operation 334 is performed to extract the decryption key from the license package. The extracted decryption key is then used to decrypt the encrypted model at the decrypt-model operation 335. The decrypted model is then stored within the secure memory to which the PAI server 212 has access. The decrypted model may then be used to locally process and analyze new input data. In examples where the model is in an ONNX model package, the model package is compiled/translated into DirectML to be executed by the GPU and/or NPU. An independent hardware vendor (IHV) driver may then translate the DirectML commands into microcode blocks which are submitted to the IHV kernel driver for execution.

Once the model is decrypted, installed, and ready for use, an acknowledgement message 336 is sent from the PAI server 212 to the PAI client 210 indicating that the model is ready. The acknowledgement is then passed to the application 208 as acknowledgement message 338. Based on the acknowledge message, the application 208 is aware that input data can now be provided as input for the model.

The application 208 then sends, to the PAI client 210, input data 340 for the model to process. The PAI client 210 may adjust or package the input data in some examples. For instance, in some cases the input data is translated into commands for the specific model, which may include translating into DirectML commands or similar command types. In other examples, the input data is not modified. The PAI client 210 then transmits the input data 342 to the PAI server 212. The model then processes the input data while executing in the secure PAI process 206.

The output data 344 that is generated from the model is transmitted from the PAI server 212 to the PAI client 210. The PAI client 210 may adjust and/or package the output data. In other examples, the PAI client 210 does not adjust or modify the output data. The output data 346 is then transmitted to the application process 204.

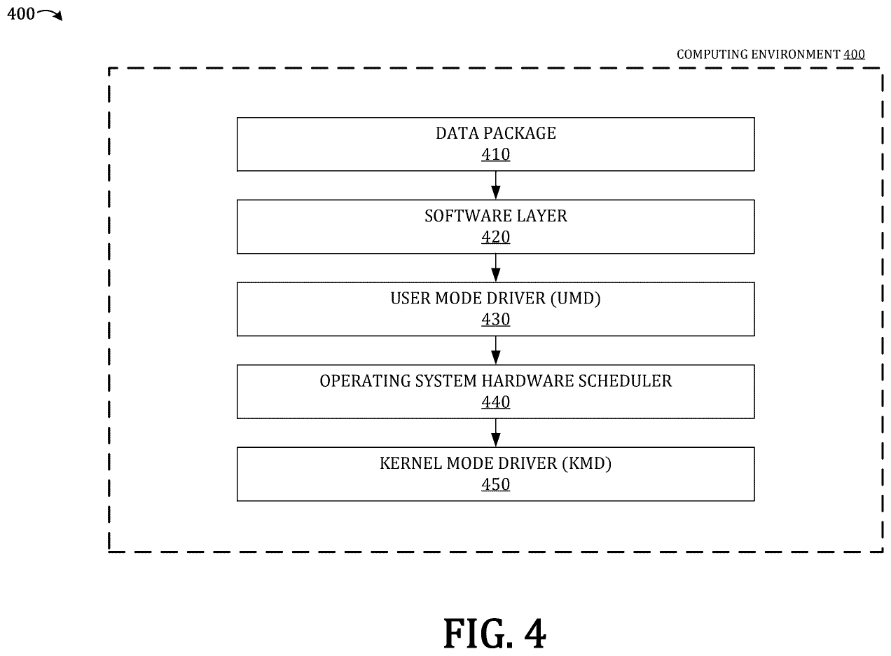

FIG. 4 depicts an example computing environment 400 for providing control of input, output, and processing of an AI model. In examples, it is contemplated that computing environment 400 comprises similar (or the same) components and provides similar (or the same) functionality as computing environment 202 discussed above. However, computing environment 400 is not limited to such examples.

In at least some examples, computing environment 400 receives a request to instantiate or execute an AI model in computing environment 400. The request includes user input data comprising a query, a statement, and/or other instructions related to the performance of one or more tasks. In some examples, the user input data is provided by an application (e.g., application 208) implemented by or accessible to computing environment 400. In response to receiving the user input data and/or determining that the user input data will invoke the AI model, the application may provide the user input data to a model processing component of computing environment 400 (e.g., PAI container 206). The model processing component provides a secure computing environment for compiling or assembling the AI model and executing the compiled or assembled AI model.

In FIG. 4, computing environment 400 comprises data package 410, software layer 420, user mode driver (UMD) 430, operating system (OS) hardware scheduler 440, and kernel mode driver (KMD) 450. Although computing environment 400 is depicted as comprising a particular combination of hardware and software components, the scale and structure of hardware and software components described herein may vary and may include additional or fewer components than those described in FIG. 4.

Data package 410 is a collection of files relating to various portions of an AI model. Data package 410 may be provided in a file type that can be executed on multiple computing platforms and computing devices. In some examples, data package 410 is provided to computing environment 400 (e.g., by distributed servers 110) in an executable format (e.g., pre-compiled or pre-assembled). In other examples, data package 410 is provided to computing environment 400 to be compiled (or assembled) and executed by computing environment 400. For instance, data package 410 may comprise at least model data and model structure information for the AI model. The model data includes, for example, model weights, which are numerical values representing learnable parameters that convey the importance of particular user input data features in predicting a final output. The model structure information includes, for example, software code, operators, and topology. The software code refers to instructions for compiling, assembling, and/or executing the AI model. The operators are characters that represent a specific mathematical or logical action or process that can be performed on data elements, such as variables. Examples of operators include activation operators, element-wise operators, convolution operators, reduction operators, pooling operators, and neural network operators. The topology refers to the structure of the layer architecture that is used to process and transform user input data provided to the AI model. For instance, the topology may provide a mapping between user input data provided to a first layer and outputs of the first data that are provided as input to a second layer.

In examples, the model data and the model structure information (or potions thereof) may each be encrypted using a different security mechanism (e.g., a security key or a digital certificate). For instance, a license for the AI model may store a security key that is used to encrypt the model data of the AI model and store a different security key that is used to encrypt the model structure information of the AI model. Additionally or alternatively, user input data and user output data may also be encrypted using a different security mechanism. For instance, the license for the AI model may store a security key that is used to encrypt user input data provided to the AI model and store a different security key that is used to encrypt user output data that is provided in response to the user input data. In one example, source code (e.g., software code that is not compiled or translated) and compiled or translated software code may also be encrypted using a different security mechanism. For instance, the license for the AI model may store a security key that is used to encrypt source code of the AI model (or the license may not store a security key that is used to encrypt the source code) and store a different security key that is used to encrypt compiled or translated software code.

Data package 410 is translated to a first set of commands in an intermediate language that is executable by software layer 220. In examples, the first set of commands represents the model data and the model structure information associated with a compiled or assembled version of the AI model. Translating data package 410 to the first set of commands obfuscates the original content of data package 410 and assists in preventing the original content of data package 410 from being accessed by unauthorized parties. Data package 410 is translated into the first set of commands using a data package runtime environment of computing environment 400. In examples, the data package runtime environment is a computing environment that optimizes and accelerates machine learning (ML) inferencing and enables cross-platform deployment of AI models. The data package runtime environment may be code signed to provide additional security for the first set of commands. Code signing is the process of digitally signing software (e.g., executables and scripts) to confirm the software author (e.g., the developer) or distributor and guarantee that the software has not been modified after being code signed. In some examples, as part of translating data package 410 into the first set of commands, the data package runtime environment associates execution sequencing enforcement data with the first set of commands. For instance, the data package runtime environment may assign a sequence number or identifier to each command in the first set of commands to ensure that logical steps are executed in accordance with the initial execution plan of the AI model.

Software layer 420 is or includes one or more an application programming interfaces (APIs) and/or software libraries that provide an optimized path for hardware device acceleration. Software layer 420 includes a software layer runtime environment that translates the first set of commands to a second set of commands corresponding to one or more hardware devices of (e.g., implemented within or attached to) computing environment 400, such as CPUs, GPUs, NPUs, and digital signal processor (DSP) accelerators configured to process two-dimensional (2D) and three-dimensional (3D) graphical data. The software layer runtime environment may be code signed to provide additional security for the second set of commands. Translating the first set of commands to a second set of commands includes allocating memory (e.g., system memory of computing environment 400) for one or more portions of the AI model (represented by the first set of commands) and/or user input data received by the AI model, loading the portions of the AI model and/or user input data into the allocated memory, and performing operations on portions of the AI model and/or the user input data placed in the allocated memory. For instance, software layer 420 may allocate memory for the model weights, load the model weights into the allocated memory, and perform one or more convolution operators between various model weights in the allocated memory and the user input data to generate the second set of commands.

In examples, software layer 420 uses a memory protection technique, such as memory encryption or memory partitioning, when loading the portions of the AI model and/or the user input data into the allocated memory. Additional enforcement logic may then be used to control the use of or interactions with (or between) the data loaded into the different regions of the allocated memory. Memory encryption refers to the process of using a security key to encrypt data stored in memory such that the encrypted data stored in the memory is only accessible using the security key. In some examples, different security keys may be used to encrypt different types of data stored in memory. For instance, a first security key may be used to encrypt model data, a second security key may be used to encrypt model structure information, and a third security key may be used to encrypt the user input data. Memory partitioning refers to the process of dividing memory into partitions (e.g., sections) that are each assigned to be allocated for a particular type of data. For instance, a first range of the memory (e.g., a lower quarter of the memory) may be allocatable for user input data, a second range of the memory (e.g., the next quarter of the memory) may be allocatable for model data, and a third range of the memory (e.g., the upper half of the memory) may be allocatable for model structure information.

The second set of commands is provided to user mode driver (UMD) 430. In examples, UMD 430 is a software component that manages hardware devices of computing environment 400. UMD 430 may run in a separate memory space from the kernel of computing environment 400 and communicate with the hardware devices of computing environment 400 via an interface provided by the kernel. UMD 430 translates the second set of commands into microcode that is executable by a hardware device of computing environment 400. UMD 430 may be code signed to provide additional security for the microcode. The microcode is a set of hardware-level instructions that enables higher-level machine code instructions to be executed by a hardware device. In examples, the microcode is represented by one or more microcode data blocks. A microcode data block is a sequence of data (e.g., bits or bytes) having a maximum data length (i.e., block size). Each microcode data block may include built-in operators and references to portions of the AI model represented by the microcode block. Each microcode data block may accept one or more types of user input data as input.

In examples, when a hardware device attempts to execute a microcode data block, the hardware device queries a HROT (e.g., HROT 220) of computing environment 400 to determine whether the microcode data block is authorized to generate an output for the input received by the microcode data block. For instance, the HROT may determine whether the AI model topology has been processed correctly (e.g., whether the portions of the AI model and/or user input data were allocated to the correct memory ranges), whether the AI model software code is code signed, whether the model weights are encrypted, and/or whether the input to a microcode data block includes input data. In some examples, the HROT uses a data mapping structure, such as transformation table or a data array, to determine the types of inputs a microcode data block is authorized to receive, the operations the microcode data block is authorized to perform on each authorized type of input, the outputs the microcode data block is authorized to provide, and the output destination (e.g., storage location or component of computing environment 400) to which the outputs are authorized to be provided. The data mapping structure may be stored by the HROT and accessed at AI model runtime in accordance with one or more licenses associated with the AI model. For instance, a license for the AI model may specify that a particular memory protection technique be applied to model operators or user input data.

OS hardware scheduler 440 receives microcode blocks associated with AI model. OS hardware scheduler 440 provides an algorithm for assigning processing resources (e.g., CPUs, CGPs, NPUs) and other compute resources (e.g., memory, storage, networking) for performing tasks associated with the microcode blocks. For example, OS hardware scheduler 440 may receive microcode blocks for multiple applications or services executing the AI model (or an instance thereof). OS hardware scheduler 440 determines a processing order for the microcode of each of the multiple applications or services (e.g., process microcode for application 1, then process microcode for application 4). The processing order for the microcode may be based on, for example, an execution priority for the multiple applications or services, a current or expected compute resource availability for computing environment 400, current latency or response times for computing environment 400, temporal factors (e.g., the time of day or the day of the week), or the order in which the microcode was received by OS hardware scheduler 440 (e.g., first received is first processed). Alternatively, the processing order for the microcode may be based on, for example, an interleaving format (e.g., process a first microcode block (or a first subset of microcode blocks) for application 1, process a first microcode block (or a first subset of microcode blocks) for application 2, process a second microcode block (or a second subset of microcode blocks) for application 1, process a second microcode block (or a second subset of microcode blocks) for application 2, and so on).

In some examples, OS hardware scheduler 440 modifies the microcode blocks to provide additional security for the microcode blocks. For instance, OS hardware scheduler 440 may append an identifier associated with computing environment 400 (e.g., a media access control (MAC) address, an application or service identifier, a user session identifier, or some other unique identifier) to the microcode blocks. OS hardware scheduler 440 may provide the identifier in an obfuscated form, such as a hash value or an encoded value, which may be code signed by UMD 430 or another trusted component of computing environment 400. In another instance, OS hardware scheduler 440 may add one or more data fields the microcode blocks, such as a microcode block sequence counter. The microcode block sequence counter may be used to determine whether the microcode blocks have been reordered or whether one or more microcode blocks have been added or removed (e.g. in further of an attack attempt or as a result of data corruption). In yet another instance, OS hardware scheduler 440 may encrypt the microcode blocks or portions of the microcode blocks. The portions to be encrypted may be based on the protections assigned to the various portions of the AI model (e.g., the model data and the model structure information). As one example, if a license for the AI model specifies that software code of the AI model is to be protected using hardware-based encryption (e.g., a high level of protection) and the model weights for the AI model are to be protected using software-based encryption (e.g., a lower level of protection), software code of the AI model that is included within a microcode block may be encrypted, whereas model weights included within a microcode block may not be encrypted.

OS hardware scheduler 440 provides the microcode blocks to KMD 450. In examples, KMD 450 is a software component that manages hardware devices of computing environment 400. KMD 450 runs in a memory space of the kernel of computing environment 400 and is able communicate directly with the hardware devices. KMD 450 provides the received microcode blocks to the hardware devices. The hardware devices then execute the commands in the microcode blocks and provide a resultant output of the execution. The resultant output is used to provide user output data that is responsive to the user input data. For instance, the user output data may be processed (e.g., formatted to add, remove, or obfuscate content) and provided to the application that provided the request to instantiate or execute the AI model.

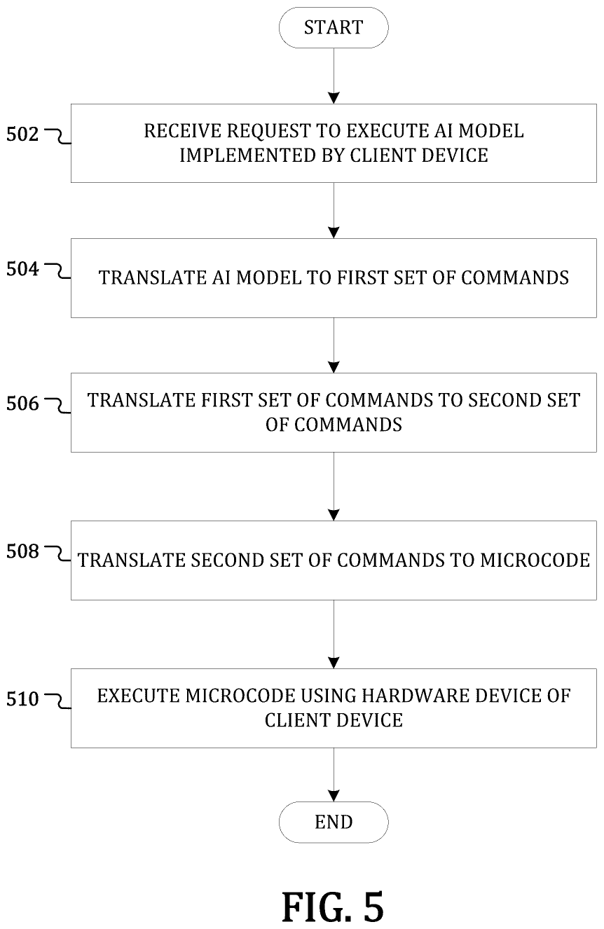

FIG. 5 illustrates an example method 500 for providing control of input, output, and processing of an AI model. Method 500 may be performed by one or more of the devices or components of the systems described above. In an example, methods 500 is performed by client devices 102 and/or computing environment 202.

Method 500 begins at operation 502, where a request to execute an AI model implemented by a client device is received. In examples, an application (e.g., application 208) implemented by the client device (e.g., client devices 102) provides the request to a model processing environment (e.g., PAI container 206). The request includes user input data relating to the performance of one or more tasks by at least one hardware device (e.g., CPU, GPU, NPU, or 3D engine) of the client device. The model processing environment may store a compiled or assembled version of the AI model. Alternatively, the model processing environment may store or receive (e.g., via the request) an uncompiled or unassembled version of the AI model. In examples in which the AI model is uncompiled or unassembled when the request is received, the model processing environment may compile or the assemble the AI model into an executable format that enables the AI model to process the user input data.

The AI model is associated with at least one license. The license specifies security requirements for the AI model, such as the permitted usage of the AI model, the requisite hardware and/or software capabilities of the client device for executing the AI model, and the requisite protections the client device is to provide for received user data and various portions of the AI model (e.g., model data and model structure information). The license may also store one or more security keys used to encrypt and/or decrypt the model or the various portions thereof.

At operation 504, the AI model is translated to a first set of commands. In examples, a data package runtime environment of the client device is used to translate the AI model and/or the user input data into an intermediate language (e.g., ONNX or Open AI's Triton) that is processable by a software layer, such as software layer 220. The software layer may provide the application that provided the request an optimized path for hardware device acceleration and may enable ML techniques such as upscaling, anti-aliasing, and style transfer. Translating the AI model and/or the user input data into the first set of commands obfuscates the original content of the AI model and/or the user input data to prevent access by unauthorized parties.

At operation 506, the first set of commands is translated into a second set of commands. In examples, a software layer runtime environment of the client device is used to translate the first set of commands into a second set of commands that is processable by a hardware device of the client device. Translating the first set of commands to a second set of commands includes allocating memory of the client device for one or more portions of the AI model and/or user input data represented by the first set of commands and loading the portions of the AI model and/or user input data into the allocated memory in accordance with one or more memory protection techniques. For example, a license for the AI model may specify that memory partitioning is to be used to secure the portions of the AI model and/or the user input data. As a result, a first portion of the AI model (e.g., the model data) is placed in a first range of memory addresses, a second portion of the AI model (e.g., the model structure information) is placed in a second range of the memory addresses, and the user input data is placed in a third range of the memory. In one example, the sub-portions of the portions of the AI model are also allocated and placed into separate memory ranges. For instance, the sub-portions of the model structure information may be allocated memory such that a first range (or subrange) of memory addresses is allocated for software code of the AI model, a second range (or subrange) of memory addresses is allocated for operators of the AI model, and a third range (or subrange) of memory addresses is allocated for topology of the AI model. Translating the first set of commands to a second set of commands further includes perform one or more convolution operators between various model weights in the allocated memory and the user input data to generate the second set of commands.

At operation 508, the second set of commands is translated into microcode. In examples, the second set of commands is provided to a first driver component (e.g., UMD 430), which translates the second set of commands into microcode that is executable by a hardware device of the client device. For instance, the microcode may be a set of hardware-level instructions that is configured to be executed by a GPU or an NPU. The microcode may be represented as a set of microcode blocks that each include built-in operators (e.g., operators of the AI model) and references to portions of the AI model represented by the microcode block. Each microcode data block may be authorized to accept one or more types of user input data as input, to perform certain types of operations, and to provide one or more types of user output data.

At operation 510, a hardware device executes the microcode. In examples, the microcode is provided to a corresponding hardware device. The hardware device then executes the microcode in furtherance of the request received from the application. In some examples, when executing (or attempting to execute) the microcode, the hardware device queries a HROT (e.g., HROT 220) of the client device to determine whether the microcode data block is authorized to generate an output for the input received by the microcode data block. For instance, the HROT may access a data mapping that specifies authorized data inputs, operations, and data outputs for microcode data blocks (e.g., based on memory protections for allocated memory corresponding to data included in the microcode data block). If the HROT confirms that the hardware device is authorized to execute the microcode, the hardware device executes the microcode and provides user output data, which is provided to the application. However, if the HROT does not confirm that the hardware device is authorized to execute the microcode, execution of the hardware device may be halted and the hardware device may be put into a blocked state (e.g., preventing the device for execution of the AI model and/or the application).

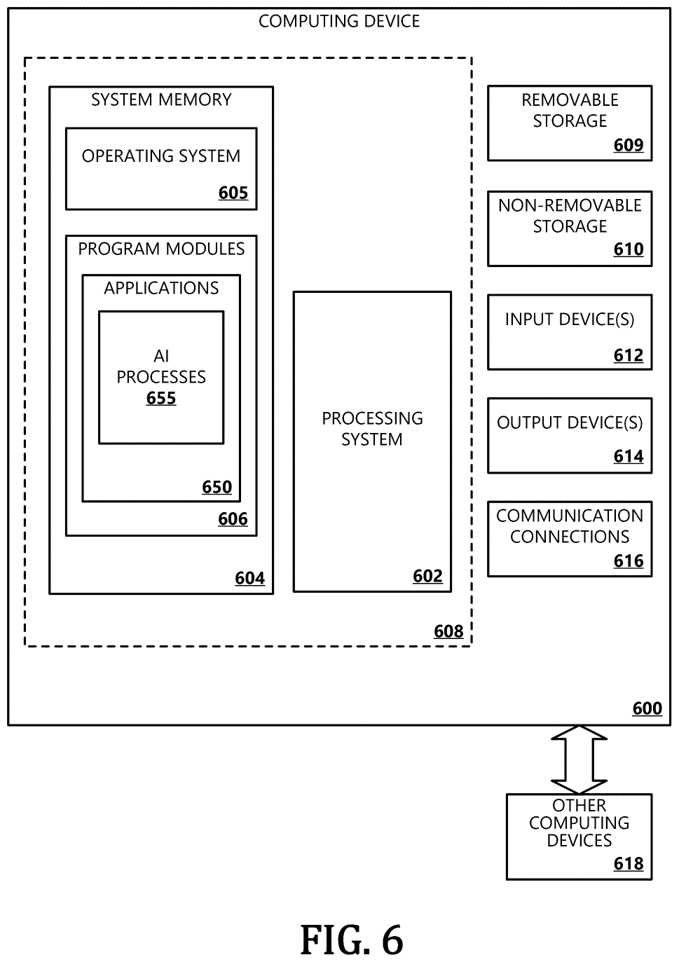

FIG. 6 is a block diagram illustrating physical components (e.g., hardware) of a computing device 600 with which aspects of the disclosure may be practiced. The computing device components described below may be suitable for the computing devices and systems described above. In a basic configuration, the computing device 600 includes at least one processing system 602 and a system memory 604. Depending on the configuration and type of computing device, the system memory 604 comprises volatile storage (e.g., random access memory (RAM)), non-volatile storage (e.g., read-only memory (ROM)), flash memory, or any combination of such memories.

The system memory 604 includes an operating system 605 and one or more program modules 606 suitable for running software application 620, such as one or more components supported by the systems described herein. The operating system 605, for example, is suitable for controlling the operation of the computing device 600.

Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, or optical disks. Such additional storage is illustrated in FIG. 6 by a removable storage device 607 and a non-removable storage device 610.

As stated above, a number of program modules and data files may be stored in the system memory 604. While executing on the processing system(s) 602, the program modules 606 (e.g., application 620) may perform processes including the aspects described herein. Other program modules that may be used in accordance with aspects of the present disclosure include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing systems/units, graphics units, communications units, system virtualization units and various application functionality all of which are integrated (or “burned”) onto the chip substrate as a single integrated circuit. When operating via an SOC, the functionality described herein with respect to the capability of a client to switch protocols, may be operated via application-specific logic integrated with other components of the computing device 600 on the single integrated circuit (chip). Embodiments of the disclosure may also be practiced using other technologies capable of performing logical operations such as, for example, AND, OR, and NOT, including mechanical, optical, fluidic, and quantum technologies. In addition, embodiments of the disclosure may be practiced within a general-purpose computer or in any other circuits or systems.

The computing device 600 also has one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 607, and the non-removable storage device 610 are all computer storage media examples (e.g., memory storage). Computer storage media includes RAM, ROM, electrically erasable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

As will be understood from the present disclosure, one example of the technology discussed herein relates to a system comprising: a processing system; and memory coupled to the processing system, the memory comprising computer executable instructions that, when executed, perform operations comprising: receiving a request to execute an artificial intelligence (AI) model implemented by a client device, the AI model comprising model weights and a model structure; translating the AI model to a first set of commands; translating the first set of commands into a second set of commands, wherein the model weights are protected in the memory based on a first protection level specified by a license for the AI model and the model structure in protected in the memory based on a second protection level specified by the license; translating the second set of commands into microcode corresponding to a hardware device of the system; and executing, by the hardware device, the microcode in furtherance of the request to execute the AI model.

In another example, the technology discussed herein relates to a method comprising: receiving, by a client device, a request to execute an artificial intelligence (AI) model implemented by the client device, the AI model comprising model weights and a model structure; translating the AI model to operations in an intermediate language; translating the operations in the intermediate language into hardware commands, wherein the model weights are protected in a memory of the client device based on a first protection level specified by a license for the AI model and the model structure in protected in the memory based on a second protection level specified by the license; translating the hardware commands into microcode corresponding to a hardware device accessible to the client device; and executing, by the hardware device, the microcode in furtherance of the request to execute the AI model.

In another example, the technology discussed herein relates to a device comprising: a processing system; and memory coupled to the processing system, the memory comprising computer executable instructions that, when executed, perform operations comprising: receiving a request to execute an artificial intelligence (AI) model using the device, the AI model comprising model weights and a model structure in a first software language; loading the AI model into the memory as a first set of commands, wherein the model weights are protected in the memory based on a first protection level specified by a license for the AI model and the model structure in protected in the memory based on a second protection level specified by the license; translating the first set of commands into a second set of commands that is executable by a hardware device of the device; and executing, by the hardware device, the second set of commands in furtherance of the request to execute the AI model.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, it is envisioned that variations, modifications, and alternate aspects fall within the spirit of the broader aspects of the general inventive concept embodied in this application do not depart from the broader scope of the claimed disclosure.

What is claimed is:

1. A system comprising:
a processing system; and
memory comprising computer executable instructions that, when executed, perform operations comprising:
receiving a request to execute an artificial intelligence (AI) model implemented by a client device, the AI model comprising model weights and a model structure;
translating the AI model to a first set of commands;
translating the first set of commands into a second set of commands, wherein the model weights are protected in the memory based on a first protection level specified by a license for the AI model and the model structure in protected in the memory based on a second protection level specified by the license;
translating the second set of commands into microcode corresponding to a hardware device of the system; and
executing, by the hardware device, the microcode in furtherance of the request to execute the AI model.

2. The system of claim 1, wherein an application implemented by the client device provides the request to a model processing environment.

3. The system of claim 2, wherein the model processing environment is a protected artificial intelligence (AI) container comprising a protected AI server.

4. The system of claim 3, wherein the protected AI server performs operations on the AI model, the operations including at least one of decryption operations, validation operations, or inference operations.

5. The system of claim 3, wherein the protected AI server includes a hardware root of trust that is trusted to enforce security requirements of the license for the AI model.

6. The system of claim 1, wherein the license for the AI model stores at least one security key used to encrypt the AI model or at least one portion of the AI model.

7. The system of claim 1, wherein the first set of commands represent an intermediate language that is processable by a software layer that provides an application that provided the request to execute the AI model an optimized path for hardware device acceleration.

8. The system of claim 1, wherein translating the first set of commands into the second set of commands includes:
allocating portions of the memory for the model weights and the model structure; and
loading the model weights into a first portion of the portions of the memory in accordance with the first protection level; and
loading the model structure into a second portion of the portions of the memory in accordance with the second protection level.

9. The system of claim 8, wherein translating the first set of commands into the second set of commands further includes:
performing a convolution operator between at least one of the model weights in the first portion of the portions of the memory and user input data provided to the AI model.

10. The system of claim 8, wherein the first portion of the portions of the memory represents a first range of memory addresses and the second portion of the portions of the memory represents a second range of memory addresses that is different from the first range of memory addresses.

11. The system of claim 10, wherein a third portion of the portions of the memory represents a third range of memory addresses for user input data provided to the AI model.

12. The system of claim 1, wherein translating the second set of commands into the microcode comprises:
providing the second set of commands to a user mode driver component used to translate the second set of commands into microcode.

13. The system of claim 1, wherein the microcode represents a set of microcode blocks that each include built-in operators of the AI model and references to portions of the AI model.

14. The system of claim 1, wherein executing the microcode comprises querying, by the hardware device, a hardware root of trust to determine whether the microcode is authorized to generate an output for user input data received by the microcode.

15. A method comprising:
receiving, by a client device, a request to execute an artificial intelligence (AI) model implemented by the client device, the AI model comprising model weights and a model structure;
translating the AI model to operations in an intermediate language;
translating the operations in the intermediate language into hardware commands, wherein the model weights are protected in a memory of the client device based on a first protection level specified by a license for the AI model and the model structure in protected in the memory based on a second protection level specified by the license;
translating the hardware commands into microcode corresponding to a hardware device accessible to the client device; and
executing, by the hardware device, the microcode in furtherance of the request to execute the AI model.

16. The method of claim 15, wherein:
the request comprises user input data;
translating the AI model comprises translating the user input data to the intermediate language; and
translating the hardware commands comprises translating the user input data into the microcode.

17. The method of claim 15, wherein the model weights are numerical values representing learnable parameters that convey an importance of user input data features in predicting a final output.

18. The method of claim 15, wherein the model structure includes at least two of:
instructions for compiling or assembling the AI model;
characters representing a specific mathematical or logical action that can be performed on data elements; or
a structure of a layer architecture that is used to process and transform user input data provided to the AI model.

19. The method of claim 15, wherein the microcode is a set of hardware-level instructions that is configured to be executed by a graphics processing unit or a neural processing unit of the client device.

20. A device comprising:
a processing system; and
memory comprising computer executable instructions that, when executed, perform operations comprising:
receiving a request to execute an artificial intelligence (AI) model using the device, the AI model comprising model weights and a model structure in a first software language;
loading the AI model into the memory as a first set of commands, wherein the model weights are protected in the memory based on a first protection level specified by a license for the AI model and the model structure in protected in the memory based on a second protection level specified by the license;
translating the first set of commands into a second set of commands that is executable by a hardware device of the device; and
executing, by the hardware device, the second set of commands in furtherance of the request to execute the AI model.
